(19) United States
(12) Patent Application Publication
(10) Pub. No.: US 2024/0128499 A1
(43) Pub. Date: Apr. 18, 2024

(54) POSITIVE ELECTRODE FOR ALL-SOLID-STATE RECHARGEABLE BATTERY AND ALL-SOLID-STATE RECHARGEABLE BATTERY

(71) Applicant: SAMSUNG SDI CO., LTD., Yongin-si (KR)

(72) Inventors: Pilsang YUN, Yongin-si (KR); Do-Yu KIM, Yongin-si (KR); Hyunbeom KIM, Yongin-si (KR)

(21) Appl. No.: 18/378,737

(22) Filed: Oct. 11, 2023

(30) Foreign Application Priority Data
Oct. 14, 2022 (KR) 10-2022-0132692

(51) Int. Cl. H01M 10/0562; H01M 4/36; H01M 4/505; H01M 4/525

(52) U.S. Cl. CPC H01M 10/0562; H01M 4/366; H01M 4/505; H01M 4/525; H01M 2004/028

(57) ABSTRACT

A positive electrode for an all-solid-state rechargeable battery, the positive electrode includes a current collector; and a positive electrode active material layer on the current collector, wherein the positive electrode active material layer includes a positive electrode active material and a solid electrolyte, the solid electrolyte includes sulfide solid electrolyte particles, and a lithium-metal-oxide on a surface of the sulfide solid electrolyte particles, and in an X-ray diffraction analysis of the solid electrolyte, a full width at half maximum of a main peak is less than or equal to about 0.160.

### CROSS-REFERENCE TO RELATED APPLICATION

This application claims priority to and the benefit of Korean Patent Application No. 10-2022-0132692 filed in the Korean Intellectual Property Office on Oct. 14, 2022, the entire contents of which are incorporated herein by reference.

### BACKGROUND

### 1. Field

A positive electrode for an all-solid-state rechargeable battery and an all-solid rechargeable battery are disclosed.

### 2. Description of the Related Art

Recently, as a risk of explosion of a battery using a liquid electrolyte has been reported, development of an all-solid-state battery has been actively conducted.

### SUMMARY

The embodiments may be realized by providing a positive electrode for an all-solid-state rechargeable battery, the positive electrode including a current collector; and a positive electrode active material layer on the current collector, wherein the positive electrode active material layer includes a positive electrode active material and a solid electrolyte, the solid electrolyte includes sulfide solid electrolyte particles, and a lithium-metal-oxide on a surface of the sulfide solid electrolyte particles, and in an X-ray diffraction analysis of the solid electrolyte, a full width at half maximum of a main peak is less than or equal to about 0.160.

The metal may be Al, B, Ca, Ce, Cr, Fe, Mg, Mo, Nb, Si, Sn, Sr, Ta, V, W, or Zr.

The lithium-metal-oxide may be included in the solid electrolyte in an amount of about 0.01 wt % to about 3 wt %, based on a total weight of the solid electrolyte.

The lithium-metal-oxide may be included in the solid electrolyte in an amount of about 0.01 wt % to about 0.8 wt %, based on a total weight of the solid electrolyte.

The lithium-metal-oxide may be amorphous.

The sulfide solid electrolyte particles may include an argyrodite-type sulfide.

An average particle diameter (D50) of the solid electrolyte may be about 0.1 μm to about 5.0 μm.

An average particle diameter (D50) of the sulfide solid electrolyte may be about 0.1 μm to about 2.0 μm.

A value of (D90−D10)/D50 in a particle size distribution for the solid electrolyte may be greater than about 1 and less than or equal to about 5.

The solid electrolyte may be included in the positive electrode active material layer in an amount of about 0.5 wt % to about 35 wt %, based on a total weight of the positive electrode active material layer.

The positive electrode active material may be in the form of particles, and the particles may not include a buffer layer.

The positive electrode active material may include a lithium cobalt oxide, lithium nickel oxide, a lithium nickel cobalt oxide, a lithium nickel cobalt aluminum oxide, a lithium nickel cobalt manganese oxide, a lithium nickel manganese oxide, a lithium manganese oxide, a lithium iron phosphate, or a combination thereof.

The positive electrode active material may include a lithium nickel oxide represented by Chemical Formula 1, a lithium cobalt oxide represented by Chemical Formula 2, a lithium iron phosphate compound represented by Chemical Formula 3, or a combination thereof,

Liₐ₁Niₓ₁M¹_{y1}M²_{1-x1-y1}O₂ [Chemical Formula 1]

in Chemical Formula 1, 0.9≤a1≤1.8, 0.3≤x1≤1, 0≤y1≤0.7, and M¹ and M² are each independently Al, B, Ba, Ca, Ce, Co, Cr, Cu, F, Fe, Mg, Mn, Mo, Nb, P, S, Si, Sr, Ti, V, W, or Zr,

Liₐ₂Coₓ₂M³₁₋ₓ₂O₂ [Chemical Formula 2]

in Chemical Formula 2, 0.9≤a2≤1.8, 0.6≤x2≤1, and M³ is Al, B, Ba, Ca, Ce, Cr, Cu, F, Fe, Mg, Mn, Mo, Nb, P, S, Si, Sr, Ti, V, W, or Zr, and

Liₐ₃Feₓ₃M⁴₍₁₋ₓ₃₎PO₄ [Chemical Formula 3]

in Chemical Formula 3, 0.9≤a3≤1.8, 0.6≤x3≤1, and M⁴ is Al, B, Ba, Ca, Ce, Co, Cr, Cu, F, Fe, Mg, Mn, Mo, Nb, P, S, Si, Sr, Ti, V, W, or Zr.

An average particle diameter (D50) of the positive electrode active material may be about 3 μm to about 25 μm.

The positive electrode active material layer may include about 50 wt % to about 99.5 wt % of the positive electrode active material, about 0.5 wt % to about 35 wt % of the solid electrolyte, about 0 wt % to about 10 wt % of a binder, and about 0 wt % to about 5 wt % of a conductive material, based on a total weight of the positive electrode active material layer.

The embodiments may be realized by providing an all-solid-state rechargeable battery including the positive electrode according to an embodiment; a negative electrode; and a solid electrolyte layer between the positive electrode and the negative electrode.

The negative electrode may include a current collector and a negative electrode active material layer or a negative electrode catalyst layer on the current collector.

The negative electrode may include a current collector, a negative electrode catalyst layer on the current collector, and a lithium metal layer formed during initial charging between the current collector and the negative electrode catalyst layer.

The solid electrolyte layer may include a solid electrolyte, and an average particle diameter (D50) of the solid electrolyte included in the positive electrode may be smaller than an average particle diameter (D50) of the solid electrolyte included in the solid electrolyte layer.

The average particle diameter (D50) of the solid electrolyte included in the positive electrode may be about 0.5 μm to about 2.0 and the average particle diameter (D50) of the solid electrolyte included in the solid electrolyte layer may be about 2.1 μm to about 5.0 μm.

### BRIEF DESCRIPTION OF THE DRAWINGS

Features will be apparent to those of skill in the art by describing in detail exemplary embodiments with reference to the attached drawings in which:

FIGS. 1 and 2 are schematic cross-sectional views of an all-solid rechargeable battery according to some example embodiments.

FIG. 3 shows particle size distribution curves for the solid electrolytes prepared in Example 2 and Comparative Examples 1 and 2.

FIG. 4 shows particle size distribution curves for the solid electrolytes prepared in Examples 2, 3, and 4 and Comparative Example 2.

FIG. 5 is an X-ray diffraction graph of the solid electrolytes and lithium-zirconium-oxide (LZO) according to Examples 1, 2, and 5, and Comparative Examples 1 and 2.

FIG. 6 is an X-ray diffraction graph of the solid electrolytes, LZO, lithium-aluminum-oxide (LAO), lithium-titanium-oxide (LTO) according to Examples 2 to 4, and Comparative Example 1.

FIG. 7 is a graph showing full width at half maximum (bar graph, left vertical axis) of the main peak and ion conductivity (dotted line graph, right vertical axis) in the X-ray diffraction analysis of the solid electrolytes of Examples 1 to 5 and Comparative Examples 1 to 2.

FIG. 8 is a graph showing moisture stability evaluation for the solid electrolytes of Examples 1, 2, and 5 and Comparative Example 2, and is a graph showing ion conductivity before and after being left for 3 days.

FIG. 9 is a graph showing moisture stability evaluation for the solid electrolytes of Examples 2 to 4 and Comparative Example 2, and is a graph showing ion conductivity before and after being left for 3 days.

FIG. 10 is a graph showing voltage change according to capacity as initial charge and discharge characteristics for the all-solid-state rechargeable battery cells according to Example 1 and Comparative Example 2.

FIG. 11 is a graph showing capacity retention rates according to the number of cycles as cycle-life characteristics of the all-solid-state rechargeable battery cells according to Examples 1, 2, and 5 and Comparative Examples 2 and 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that if/when a layer is referred to as being “between” two layers, it can be the only layer between the two layers, or one or more intervening layers may also be present. Like reference numerals refer to like elements throughout.

The terminology used herein is used to describe embodiments only, and is not intended to limit the embodiments. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of 50 volume % in a particle size distribution.

Herein, “or” is not to be construed as an exclusive meaning, for example, “A or B” is construed to include A, B, A+B, and the like.

Positive Electrode for All-Solid-State Rechargeable Battery

In some example embodiments, a positive electrode for an all-solid-state rechargeable battery may include a current collector and a positive electrode active material layer on the current collector. The positive electrode active material layer may include a positive electrode active material and a solid electrolyte. In an implementation, the solid electrolyte may include, e.g., sulfide solid electrolyte particles and lithium-metal-oxide on the surface of the particles. In an X-ray diffraction analysis of the solid electrolyte, a full width at half maximum of a main peak may be less than or equal to about 0.160.

The positive electrode for an all-solid-state rechargeable battery may include a solid electrolyte having a uniform particle size distribution, high ion conductivity and high crystallinity, and excellent moisture stability, so that ion conductivity may be improved, thereby improving charging and discharging efficiency of the all-solid-state rechargeable battery. A carrier depletion layer may be controlled to help improve the capacity during the cycle-life. A reaction between the positive electrode active material and the solid electrolyte may be suppressed to help improve the capacity retention rate during the cycle-life. In the positive electrode according to the embodiment, it is possible to use the positive electrode active material without a buffer layer, e.g., the positive electrode active material of liquid electrolyte systems as it is. Even if such a positive electrode active material were to be used, capacity characteristics, charge and discharge efficiency, and cycle-life of the all-solid-state rechargeable battery characteristics may be improved.

Solid Electrolyte

The solid electrolyte may be one in which a lithium-metal-oxide is present in a film form or an island form on the surface of sulfide solid electrolyte particles. The solid electrolyte may include sulfide solid electrolyte particles and a coating layer on the surface of the particles, and the coating layer may include a lithium-metal-oxide.

The solid electrolyte has a form in which a lithium-metal-oxide is coated on the surface of sulfide solid electrolyte particles, and crystallinity of the solid electrolyte is sufficiently high to realize excellent ion conductivity and at the same time to have an appropriate particle size distribution without particle aggregation. As the crystallinity of the solid electrolyte increases or the size of the crystal increases, a full width at half maximum (FWHM) of a main peak may decrease in an X-ray diffraction analysis. The solid electrolyte according to some example embodiments may have a full width at half maximum of the main peak of less than or equal to about 0.160. Herein, the main peak refers to a peak having the highest diffraction intensity in X-ray diffraction analysis. The full width at half maximum of the main peak in the X-ray diffraction analysis of the solid electrolyte according to some example embodiments may be, e.g., less than or equal to about 0.159, or less than or equal to about 0.155. The ion conductivity may be improved as the full width at half maximum is reduced, e.g., as the crystallinity is increased. In an implementation, the crystal size may be increased, the grain boundary may be reduced, and the ion conductivity may be improved.

Sulfide solid electrolytes may have aggregated particles or may have a large particle size immediately after synthesis. They may be subjected to a process such as pulverization to adjust them to a particle size usable in a battery, the crystallinity may be lowered, and the ion conductivity may be lowered. In the solid electrolyte according to some example embodiments, by heating sulfide solid electrolyte particles in a specific temperature range while coating a lithium-metal-oxide thereon, the crystallinity may be increased to adjust the full width at half maximum of the main peak to less than or equal to about 0.160. The particles may have an even particle size distribution without aggregation or growth, and the ion conductivity can be further improved.

Sulfide Solid Electrolyte Particles

The sulfide solid electrolyte particles may include, e.g., Li₂S—P₂S₅, Li₂S—P₂S₅—LiX (in which X is a halogen element, e.g., I or Cl), Li₂S—P₂S₅₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂B₃—LiI, Li₂S—SiS₂—P₂S₅—LiI, Li₂S—B₂S₃, Li₂S—P₂S₅—ZₘSₙ (in which m and n is each an integer and Z is Ge, Zn or Ga), Li₂S—GeS₂, Li₂S—SiS₂—Li₃PO₄, Li₂S—SiS₂-LiₚMO_{q} (in which p and q each an integer and M is P, Si, Ge, B, Al, Ga, or In), or a combination thereof.

Such a sulfide solid electrolyte may be obtained by, e.g., mixing Li₂S and P₂S₅ in a molar ratio of about 50:50 to about 90:10 or about 50:50 to about 80:20 and optionally performing a heat-treatment. Within the above mixing ratio ranges, a sulfide solid electrolyte having excellent ion conductivity may be prepared. The ion conductivity may be further improved by adding, e.g., SiS₂, GeS₂, B₂B₃, or the like as other components thereto.

Mechanical milling or a solution method may be applied as a mixing method of sulfur-containing raw materials for preparing a sulfide solid electrolyte. The mechanical milling may include starting materials into particulates by putting the starting materials, ball mills, and the like in a reactor and vigorously stirring them. The solution method may include mixing the starting materials in a solvent to obtain a solid electrolyte as a precipitate. In addition, in the case of heat treatment after mixing, crystals of the solid electrolyte may be more robust and ion conductivity may be improved. In an implementation, the sulfide solid electrolyte may be prepared by mixing sulfur-containing raw materials and heat-treating the mixture two or more times. In this case, a sulfide solid electrolyte having high ion conductivity and robustness may be prepared.

The sulfide solid electrolyte particles according to some example embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ion conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide may be, e.g., represented by the chemical formula, LiₐM_{b}P_{c}S_{d}Aₑ (in which a, b, c, d, and e are each independently 0 or more and 12 or less, M is Ge, Sn, Si, or a combination thereof, and A is F, Cl, Br, or I). In an implementation, it may be represented by the chemical formula of Li₇₋ₓPS₆₋ₓAₓ (in which x is 0.2 or more and 1.8 or less, and A is F, Cl, Br, or I). In an implementation, the argyrodite-type sulfide may include, e.g., Li₃PS₄, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide solid electrolyte particles including such argyrodite-type sulfide may have high ion conductivity, e.g., close to the range of about 10⁻⁴ to about 10⁻² S/cm, which is the ion conductivity of liquid electrolytes at ambient temperature, and may form an intimate bond between the positive electrode active material and the solid electrolyte without causing a decrease in ion conductivity, and also an intimate interface between the electrode layer and the solid electrolyte layer. An all-solid-state battery including the same may have improved battery performance such as rate capability, coulombic efficiency, and cycle-life characteristics.

The argyrodite-type sulfide solid electrolyte may be prepared, e.g., by mixing lithium sulfide and phosphorus sulfide, and optionally lithium halide. Heat treatment may be performed after mixing. The heat treatment may include, e.g., two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D50) of the sulfide solid electrolyte particles according to some example embodiments may be less than or equal to about 5.0 μm, e.g., about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. The sulfide solid electrolyte particles having this particle size range may effectively penetrate between positive electrode active materials, and may have excellent contact with the positive electrode active material and connectivity between solid electrolyte particles. The average particle diameter of the sulfide solid electrolyte particles may be measured using a microscope image, e.g., a particle size distribution may be obtained by measuring the size of about 20 particles in a scanning electron microscope image, and D50 may be calculated therefrom.

Lithium-Metal-Oxide

The lithium-metal-oxide is an oxide including lithium and a metal other than lithium. Herein, the metal includes general metals, transition metals, or semi-metals. In the lithium-metal-oxide, the metal may include, e.g., Al, B, Ca, Ce, Cr, Fe, Mg, Mo, Nb, Si, Sn, Sr, Ta, V, W, or Zr.

The lithium-metal-oxide may be amorphous. In an implementation, amorphous lithium-metal-oxide may be coated on the sulfide solid electrolyte particles, the prepared solid electrolyte may realize higher ion conductivity and interfacial resistance with other solid particles such as a positive electrode active material in a battery, may prevent aggregation of solid electrolyte particles, may improve ion conductivity, and may improve capacity characteristics, cycle-life characteristics, and the like.

In the solid electrolyte according to some example embodiments, the lithium-metal-oxide may be included in an amount of about 0.01 wt % to about 3 wt %, e.g., about 0.01 wt % to about 2 wt %, about 0.01 wt % to about 1 wt %, about 0.01 wt % to about 0.8 wt %, or about 0.1 wt % to about 1.0 wt %, based on a total weight of the solid electrolyte. When the content of lithium-metal-oxide is as described above, the solid electrolyte may exhibit an appropriate particle size distribution without particle aggregation while realizing high ion conductivity. In an implementation, the content of lithium-metal-oxide may be, e.g., 0.01 wt % to 0.8 wt %, based on a total weight of the solid electrolyte, and the surface of the sulfide solid electrolyte particles may be evenly coated with lithium-metal-oxide. Accordingly, the ion conductivity and moisture stability of the solid electrolyte may be further improved, and the efficiency and cycle-life characteristics of the battery may be further improved.

An average particle diameter (D50) of the solid electrolyte may be about 0.1 μm, to about 5.0 μm, e.g., about 0.1 μm to about 4.0 μm, about 0.1 μm to about 3.0 μm, about 0.5 μm to about 2.0 μm, or about 0.1 μm to about 1.5 μm. Such a solid electrolyte may help effectively penetrate between positive electrode active materials, and may have excellent contact with the positive electrode active material and connectivity between solid electrolyte particles. The average particle diameter of the solid electrolyte may be measured using a microscope image, e.g., a particle size distribution may be obtained by measuring the size of about 20 particles in a scanning electron microscope image, and D50 may be calculated therefrom.

The solid electrolyte according to some example embodiments may be characterized by having a uniform particle size distribution without particle aggregation. In an implementation, a value of (D90−D10)/D50 in the particle size distribution for the solid electrolyte may be greater than about 1 and less than or equal to about 5, e.g., about 1.1 to about 4.0, about 1.1 to about 3.0, or about 1.1 to about 2.0. The (D90−D10)/D50 value may indicate a degree of broadness of the peak in the particle size distribution graph for the solid electrolyte, e.g., the horizontal axis represents the particle size (μm) and the vertical axis represents the cumulative volume % of the particles. The smaller the corresponding number, the narrower the peak width of the graph, which may be interpreted as having a uniform particle size. Herein, D10 means a diameter of particles whose cumulative volume is 10 volume % in the particle size distribution, D50 means a diameter of particles whose cumulative volume is 50 volume % in the particle size distribution, and D90 means a diameter of particles whose cumulative volume is 90 volume % in the particle size distribution.

The D10 of the solid electrolyte may be, e.g., about 0.05 μm to about 0.7 μm, about 0.05 μm to about 0.6 μm, about 0.1 μm to about 0.5 μm, or about 0.2 μm to about 0.4 μm. In an implementation, the D90 of the solid electrolyte may be, e.g., about 0.9 μm to about 5.0 μm, about 1.0 μm to about 4.0 μm, about 1.0 μm to about 3.0 μm, or about 1.2 μm to about 2.0 μm. Maintaining the particle size distribution of the solid electrolyte as described above may help ensure that battery performance may be improved by realizing high energy density while implementing excellent ion conductivity.

The solid electrolyte may have an ion conductivity of greater than or equal to about 2.9 mS/cm at 25° C., e.g., about 2.9 mS/cm to about 5.0 mS/cm, about 3.0 mS/cm to about 4.5 mS/cm, or about 3.0 mS/cm to about 4.0 mS. The ion conductivity may be measured through electrochemical impedance spectroscopy (EIS).

A solid electrolyte according to some example embodiments may be prepared by heat-treating a mixture of sulfide solid electrolyte particles and a lithium-metal-oxide at about 250° C. to about 350° C.

A solid electrolyte may have an appropriate particle size distribution to exhibit excellent ion conduction performance in a battery and implement high energy density, and implement excellent particle fluidity, e.g., a high-density electrode plate and electrolyte film. At the same time, the solid electrolyte may be able to exhibit improved ion conductivity by maintaining high crystallinity. A sulfide solid electrolyte may be a material capable of realizing high ion conductivity among various solid electrolytes. Immediately after synthesis at a high temperature, the particles may be severely aggregated or have a large particle size, and it may be necessary to pulverize them. The ion conductivity may decrease due to the pulverizing operation, and when heat treatment is performed to increase the ion conductivity, the particles could re-aggregate and grow. In an implementation, the heat treatment may be performed in a temperature range of about 250° C. to about 350° C. while coating lithium-metal-oxide on the pulverized sulfide solid electrolyte particles, the crystallinity of the solid electrolyte may be increased, the ion conductivity may be improved, and at the same time, particle aggregation and growth may be suppressed to provide a solid electrolyte having an appropriate particle size distribution.

Maintaining the temperature of the heat treatment at about 250° C. or greater may help ensure that crystallinity is sufficiently increased, and high ion conductivity is realized. Maintaining the temperature of the heat treatment at about 350° C. or less may help ensure that aggregation and growth of particles does not occur, so that an appropriate particle size distribution may be obtained, and thus crystallinity may not be lowered. The higher the heat treatment at a higher temperature, the more coating agents may be required, which could cause deterioration of the ion conductivity.

The heat treatment may be performed under a nitrogen atmosphere or an inert gas atmosphere, e.g., He, Ar, or the like. In an implementation, the heat treatment may be performed for about 0.5 to about 10 hours, e.g., for about 1 to about 8 hours. In the case of heat treatment under these conditions, the prepared solid electrolyte may realize an appropriate particle size distribution while exhibiting excellent ion conductivity.

The lithium-metal-oxide mixed in the method for preparing a solid electrolyte may be in the form of particles, and its average particle diameter (D50) may be, e.g., about 0.01 μm to about 1.0 μm, about 0.01 μm to about 0.9 μm, about 0.01 μm to about 0.8 μm, or about 0.01 μm and about 0.5 μm. The average particle diameter of the lithium-metal-oxide may be smaller than that of the sulfide solid electrolyte particles. Maintaining the particle size of the lithium-metal-oxide within the above ranges may help ensure that it can be evenly coated on the surface of the sulfide solid electrolyte particles, may help sufficiently increase ion conductivity of the solid electrolyte, and may help improve moisture stability.

A method for preparing a solid electrolyte may include, e.g., mixing and heat-treating sulfur-containing raw materials to synthesize a sulfide solid electrolyte, pulverizing the synthesized sulfide solid electrolyte, and mixing the pulverized sulfide solid electrolyte particles and lithium-metal-oxide, and performing heat treatment at about 250° C. to about 350° C. to obtain a solid electrolyte in which lithium-metal-oxide is coated on the surface of the sulfide solid electrolyte particles.

In an implementation, mixing and heat-treating sulfide solid electrolyte particles and lithium-metal-oxide may be referred to as a type of dry coating method. Unlike oxide inorganic solid electrolytes or positive electrode active materials, sulfide solid electrolytes may have characteristics in that wet coating may be difficult and vulnerable to high-temperature heat treatment, and thus the sulfide solid electrolytes may need to address or account for difficult coating conditions. In addition, wet coating methods may use organic solvents or alkoxide raw materials, and accordingly, carbon components may remain locally after coating, which may adversely affect conductivity and the like. The method of preparing a solid electrolyte may have different conditions from coating other types of solid electrolyte particles, and is also distinguished from general wet coating.

A content of the solid electrolyte may be about 0.5 wt % to about 35 wt %, e.g., about 1 wt % to about 35 wt %, about 5 wt % to about 30 wt %, about 8 wt % to about 25 wt %, or about 10 wt % to about 20 wt %, based on a total weight of the positive electrode active material layer.

Positive Electrode Active Material

The positive electrode active material may be an active material suitable for all-solid-state rechargeable battery. In an implementation, the positive electrode active material may be a compound being capable of intercalating and deintercalating lithium, and may include a compound represented by one of the following chemical formulae.

LiₐA_{1-b}X_{b}D′₂ (0.90≤a≤1.8, 0≤b≤0.5);

LiₐA_{1-b}X_{b}O_{2-c}D′_{c} (0.90≤a≤1.8, 0≤b≤0.5, 0≤c≤0.05);

LiₐE_{1-b}X_{b}O_{2-c}D′_{c} (0.90≤a≤1.8, 0≤b≤0.5, 0≤c≤0.05);

LiₐE_{2-b}X_{b}O_{2-c}D′_{c} (0.90≤a≤1.8, 0≤b≤0.5, 0≤c≤0.05);

LiₐNi_{1-b-c}Co_{b}X_{c}D′_{α} (0.90≤a≤1.8, 0≤b≤0.5, 0≤c≤0.5, 0≤a≤2);

LiₐNi_{1-b-c}Co_{b}X_{c}O_{2-α}T_{α} (0.90≤a≤1.8, 0≤b≤0.5, 0≤c≤0.05, 0≤a≤2);

LiₐNi_{1-b-c}Co_{b}X_{c}O_{2-α}T₂ (0.90≤a≤1.8, 0≤b≤0.5, 0≤c≤0.05, 0≤a≤2);

LiₐNi_{1-b-c}Mn_{b}X_{c}D′_{α} (0.90≤a≤1.8, 0≤b≤0.5, 0≤c≤0.05, 0≤a≤2);

LiₐNi_{1-b-c}Mn_{b}X_{c}O_{2-α}T_{α} (0.90≤a≤1.8, 0≤b≤0.5, 0≤c≤0.05, 0≤a≤2);

LiₐNi_{1-b-c}Mn_{b}X_{c}O_{2-α}T₂ (0.90≤a≤1.8, 0≤b≤0.5, 0≤c≤0.05, 0≤a≤2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃ (0≤f≤2);

LiₐFePO₄ (0.90≤a≤1.8).

In the chemical formulae, A may be, e.g., Ni, Co, Mn, or a combination thereof; X may be, e.g., Al, Ni, Co, Mn, Cr, Fe, Mg, Sr, V, rare earth elements, or a combination thereof; D′ may be, e.g., O, F, S, P, or a combination thereof; E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; Z may be, e.g., Cr, V, Fe, Sc, Y, or a combination thereof; and J may be, e.g., V, Cr, Mn, Co, Ni, Cu, or a combination thereof.

The positive electrode active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include a lithium nickel oxide represented by Chemical Formula 1, a lithium cobalt oxide represented by Chemical Formula 2, a lithium iron phosphate compound represented by Chemical Formula 3, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may each independently be, e.g., Al, B, Ba, Ca, Ce, Co, Cr, Cu, F, Fe, Mg, Mn, Mo, Nb, P, S, Si, Sr, Ti, V, W, or Zr.

Liₐ₂COₓ₂M³₁₋ₓ₂O₂ [Chemical Formula 2]

In Chemical Formula 2, 0.9≤a2≤1.8, 0.6≤x2≤1, and M³ may be, e.g., Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₍₁₋ₓ₃₎PO₄ [Chemical Formula 3]

In Chemical Formula 3, 0.9≤a3≤1.8, 0.6≤x3≤1, and M⁴ may be, e.g., Al, B, Ba, Ca, Ce, Co, Cr, Cu, F, Fe, Mg, Mn, Mo, Nb, P, S, Si, Sr, Ti, V, W, or Zr.

An average particle diameter (D50) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D50) of about 1 μm to about 9 μm and large particles having an average particle diameter (D50) of about 10 μm to about 20 μm. A positive electrode active material having such particle size ranges may be harmoniously mixed with other components in a positive electrode active material layer and may realize high capacity and high energy density.

The positive electrode active material may be in the form of secondary particles formed by aggregating a plurality of primary particles, or may be in the form of single particles. In an implementation, the positive electrode active material may have a spherical or near-spherical shape, or may have a polyhedral or amorphous shape.

Binder

In an implementation, the positive electrode active material layer may optionally further include a binder. The binder may facilitate attachment of the positive electrode active material particles and the solid electrolyte particles to each other, and also to facilitate attachment of the particles to the current collector. In an implementation, the binder may include, e.g., polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

In an implementation, the binder may be included in an amount of 0 wt % to about 10 wt %, about 0.1 wt % to about 10 wt %, or about 0.5 wt % to about 5 wt %, based on a total weight of each component of the positive electrode for an all-solid-state battery or a total weight of the positive electrode active material layer. Within the above content ranges, the binder may help sufficiently exhibit adhesive ability without deteriorating battery performance.

Conductive Material

In an implementation, the positive electrode active material layer may optionally further include a conductive material. The conductive material may impart conductivity to the electrode, and may include, e.g., a carbon material such as natural graphite, artificial graphite, carbon black, acetylene black, ketjen black, a carbon fiber, a carbon nanotube, or the like; a metal material including copper, nickel, aluminum, silver, or the like and in the form of a metal powder or a metal fiber; a conductive polymer such as a polyphenylene derivative; or a combination thereof.

In an implementation, the conductive material may be included in an amount of 0 wt % to about 5 wt %, about 0.1 wt % to about 5 wt %, or about 0.5 wt % to about 3 wt %, based on a total weight of each component of the positive electrode for an all-solid-state battery or a total weight of the positive electrode active material layer. In the above content ranges, the conductive material may help improve electrical conductivity without degrading battery performance.

In an implementation, the positive electrode active material layer may include about 50 wt % to about 99.5 wt % of the positive electrode active material, about 0.5 wt % to about 35 wt % of a solid electrolyte, about 0 wt % to about 10 wt % of a binder, and about 0 wt % to about 5 wt % of a conductive material.

In an implementation, the positive electrode active material layer may include about 50 wt % to about 99.3 wt % of a positive electrode active material, about 0.5 wt % to about 35 wt % of a solid electrolyte, 0.1 wt % to 10 wt % of a binder, and 0.1 wt % to 5 wt % of a conductive material.

In an implementation, the positive electrode active material layer may further include an oxide inorganic solid electrolyte in addition to the above-described solid electrolyte. The oxide inorganic solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃(PLZT) (0x≤1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤X≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (M=Te, Nb, or Zr; x is an integer of 1 to 10), or a combination thereof.

All-Solid-State Rechargeable Battery

In an implementation, an all-solid-state rechargeable battery may include the aforementioned positive electrode and negative electrode, and a solid electrolyte layer between the positive electrode and the negative electrode. The all-solid-state rechargeable battery may also be referred to as an all-solid-state battery or an all-solid-state rechargeable lithium battery.

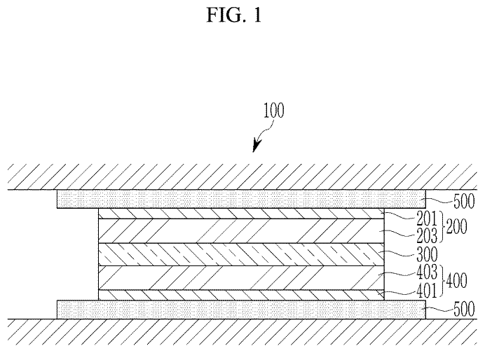

FIG. 1 is a cross-sectional view schematically illustrating an all-solid-state battery according to some example embodiments. Referring to FIG. 1, the all-solid-state battery 100 may have a structure that an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 are stacked, is inserted into a case such as a pouch and the like. The all-solid-state battery 100 may further include at least one elastic layer 500 on the outside of at least either one of the positive electrode 200 and the negative electrode 400. In an implementation, as illustrated in FIG. 1, one electrode assembly may include the negative electrode 400, the solid electrolyte layer 300, and the positive electrode 200, or two or more electrode assemblies may be stacked to manufacture an all-solid-state battery.

Negative Electrode

The negative electrode for an all-solid-state battery may include, e.g., a current collector and a negative electrode active material layer on the current collector. The negative electrode active material layer may include a negative electrode active material, and may further include a binder, a conductive material, or a solid electrolyte.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include, e.g., crystalline carbon, amorphous carbon, or a combination thereof, as a carbon negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, or the like.

The lithium metal alloy may include an alloy of lithium and another metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (in which Q is an alkali metal, an alkaline-earth metal, a Group 13 element, a Group 14 element, a Group 15 element, a Group 16 element, a transition metal, a rare earth element, and a combination thereof, and not Si) and the Sn negative electrode active material may include Sn, SnO₂, a Sn—R alloy (in which R is an alkali metal, an alkaline-earth metal, a Group 13 element, a Group 14 element, a Group 15 element, a Group 16 element, a transition metal, a rare earth element, and a combination thereof, and not Sn). At least one of these materials may be mixed with SiO₂. The elements Q and R may be, e.g., Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer on the surface of the core. The crystalline carbon may be artificial graphite, natural graphite, or a combination thereof. The amorphous carbon precursor may be a coal pitch, mesophase pitch, petroleum pitch, coal oil, petroleum heavy oil, or a polymer resin such as a phenol resin, a furan resin, or a polyimide resin. In an implementation, the content of silicon may be about 10 wt % to about 50 wt %, based on the total weight of the silicon-carbon composite. In an implementation, the content of the crystalline carbon may be about 10 wt % to about 70 wt %, based on the total weight of the silicon-carbon composite, and the content of the amorphous carbon may be about 20 wt % to about 40 wt %, based on the total weight of the silicon-carbon composite. In an implementation, a thickness of the amorphous carbon coating layer may be about 5 nm to about 100 nm.

The average particle diameter (D50) of the silicon particles may be about 10 nm to about 20 μm, e.g., about 10 nm to about 500 nm. The silicon particles may be present in an oxidized form, and an atomic content ratio of Si:O in the silicon particle indicating a degree of oxidation may be about 99:1 to about 33:67. The silicon particles may be SiOₓ particles, and a range of x in SiOₓ may be greater than about 0 and less than about 2. The average particle diameter (D50) may be measured by a microscope image or a particle size analyzer, and may mean a diameter (D50) of particles having a cumulative volume of 50 volume % in a particle size distribution.

The Si negative electrode active material or Sn negative electrode active material may be mixed with the carbon negative electrode active material. A mixing ratio of the Si negative electrode active material or Sn negative electrode active material with the carbon negative electrode active material may be a weight ratio of about 1:99 to about 90:10.

In the negative electrode active material layer, the negative electrode active material may be included in an amount of about 95 wt % to about 99 wt %, based on the total weight of the negative electrode active material layer.

In an implementation, the negative electrode active material layer may further include, e.g., a binder, and may optionally further include a conductive material. The content of the binder in the negative electrode active material layer may be about 1 wt % to about 5 wt %, based on the total weight of the negative electrode active material layer. In an implementation, the conductive material may be further included, and the negative electrode active material layer may include about 90 wt % to about 98 wt % of the negative electrode active material, about 1 wt % to about 5 wt % of the binder, and about 1 wt % to about 5 wt % of the conductive material.

The binder may facilitate adhering of the negative electrode active material particles to each other and also adhering the negative electrode active material to the current collector. The binder may be a water-insoluble binder, a water-soluble binder, or a combination thereof.

The water-insoluble binder may include, e.g., polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include, e.g., a rubber binder or a polymer resin binder. The rubber binder may include, e.g., a styrene-butadiene rubber, an acrylated styrene-butadiene rubber, an acrylonitrile-butadiene rubber, an acrylic rubber, a butyl rubber, a fluororubber, or a combination thereof. The polymer resin binder may include, e.g., polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

In an implementation, a water-soluble binder may be used as the negative electrode binder, a thickener capable of imparting viscosity may be used together therewith, and the thickener may include, e.g., a cellulose compound. The cellulose compound may include carboxymethyl cellulose, hydroxypropylmethyl cellulose, methyl cellulose, an alkali metal salt thereof, or a combination thereof. The alkali metal may be Na, K, or Li. The amount of the thickener used may be about 0.1 parts by weight to about 3 parts by weight, based on 100 parts by weight of the negative electrode active material.

The conductive material may impart conductivity to the electrode, and may include, e.g., a carbon material such as natural graphite, artificial graphite, carbon black, acetylene black, ketjen black, a carbon fiber, carbon nanotube, or the like; a metal material of a metal powder or a metal fiber including copper, nickel, aluminum silver, or the like; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

In an implementation, the negative electrode for the all-solid-state battery may be a precipitation-type negative electrode. The precipitation-type negative electrode may be a negative electrode that has no negative electrode active material during the assembly of a battery but in which a lithium metal or the like are precipitated during the charge of the battery and serve as a negative electrode active material.

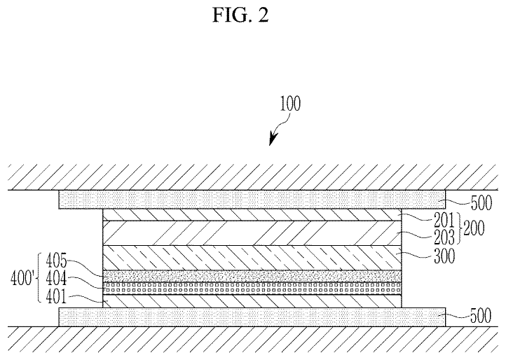

FIG. 2 is a schematic cross-sectional view of an all-solid-state battery including a precipitation-type negative electrode. Referring to FIG. 2, the precipitation-type negative electrode 400′ may include the current collector 401 and a negative electrode catalyst layer 405 on the current collector. The all-solid-state battery having this precipitation-type negative electrode 400′ may be initially charged in absence of a negative electrode active material, and a lithium metal with high density or the like may be precipitated between the current collector 401 and the negative electrode catalyst layer 405 during the charge and form a lithium metal layer 404, which may work as a negative electrode active material. Accordingly, the precipitation-type negative electrode 400′, in the all-solid-state battery which is charged more than once, may include the current collector 401, the lithium metal layer 404 on the current collector, and the negative electrode catalyst layer 405 on the metal layer 404. The lithium metal layer 404 may be a layer of the lithium metal or the like precipitated during the charge of the battery and may be called to be a metal layer, a negative electrode active material layer, or the like.

The negative electrode catalyst layer 405 may include a metal, a carbon material, or a combination thereof which plays a role of a catalyst.

The metal may include, e.g., gold, platinum, palladium, silicon, silver, aluminum, bismuth, tin, zinc, or a combination thereof, and may be composed of one selected therefrom or an alloy of more than one. In an implementation, the metal may be present in particle form, and an average particle diameter (D50) thereof may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

In an implementation, the negative electrode catalyst layer 405 may include the metal and the carbon material, and the metal and the carbon material may be, e.g., mixed in a weight ratio of about 1:10 to about 2:1. In an implementation, the precipitation of the lithium metal may be effectively promoted and improve characteristics of the all-solid-state battery. The negative electrode catalyst layer 405 may include, e.g., a carbon material on which a catalyst metal is supported or a mixture of metal particles and carbon material particles.

The negative electrode catalyst layer 405 may include, e.g., the metal and amorphous carbon, and in this case, the deposition of lithium metal may be effectively promoted.

The negative electrode catalyst layer 405 may further include a binder, and the binder may be a conductive binder. In an implementation, the negative electrode catalyst layer 405 may further include other additives, e.g., a filler, a dispersant, or an ion conducting agent.

The negative electrode catalyst layer 405 may have a thickness of, e.g., about 100 nm to about 20 μm, about 500 nm to about 10 μm, or about 1 μm to about 5 μm.

The precipitation-type negative electrode 400′ may further include a thin film, e.g., on the surface of the current collector, e.g., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and much improve characteristics of the all-solid-state battery. The thin film may be formed, e.g., using a vacuum deposition method, a sputtering method, a plating method, or the like. The thin film may have, e.g., a thickness of about 1 nm to about 500 nm.

Solid Electrolyte Layer

The solid electrolyte layer 300 may include a sulfide solid electrolyte or an oxide solid electrolyte. Details of the sulfide solid electrolyte and the oxide solid electrolyte may be as described above.

In an implementation, the solid electrolyte included in the positive electrode 200 and the solid electrolyte included in the solid electrolyte layer 300 may include the same compound or different compounds. In an implementation, both the positive electrode 200 and the solid electrolyte layer 300 may include an argyrodite-type sulfide solid electrolyte, and overall performance of the all-solid-state rechargeable battery may be improved. In an implementation, both the positive electrode 200 and the solid electrolyte layer 300 may include the aforementioned coated solid electrolyte, and the all-solid-state rechargeable battery may implement excellent initial efficiency and cycle-life characteristics while implementing high capacity and high energy density.

In an implementation, the average particle diameter (D50) of the solid electrolyte included in the positive electrode 200 may be smaller than the average particle diameter (D50) of the solid electrolyte included in the solid electrolyte layer 300. In this case, overall performance may be improved by increasing the mobility of lithium ions while maximizing the energy density of the all-solid-state battery. In an implementation, the average particle diameter (D50) of the solid electrolyte included in the positive electrode 200 may be about 0.1 μm to about 1.0 μm, or about 0.1 μm to about 0.8 μm, and the average particle diameter (D50) of the solid electrolyte included in the solid electrolyte layer 300 may be about 1.5 μm to about 5.0 μm, or about 2.0 μm to about 4.0 μm, or about 2.5 μm to about 3.5 μm. Within the particle size ranges described above, the energy density of the all-solid-state rechargeable battery may be maximized while the transfer of lithium ions is facilitated, so that resistance may be suppressed, and thus the overall performance of the all-solid-state rechargeable battery may be improved. Herein, the average particle diameter (D50) of the solid electrolyte may be measured through a particle size analyzer using a laser diffraction method. Alternatively, about 20 particles may be arbitrarily selected from a micrograph of a scanning electron microscope or the like, the particle size is measured, and a particle size distribution is obtained, and the D50 value may be calculated.

The solid electrolyte layer may further include a binder in addition to the solid electrolyte. In an implementation, the binder may include, e.g., a styrene butadiene rubber, polytetrafluoroethylene, polyvinylidene fluoride, polyethylene, an acrylate polymer, or a combination thereof. The acrylate polymer may include, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may include, e.g., isobutyryl isobutyrate, xylene, toluene, benzene, hexane, or a combination thereof.

A thickness of the solid electrolyte layer may be, e.g., about 10 μm to about 150 μm.

The solid electrolyte layer may further include an alkali metal salt or an ionic liquid and/or a conductive polymer.

The alkali metal salt may be, e.g., a lithium salt. A content of the lithium salt in the solid electrolyte layer may be greater than or equal to about 1 M, e.g., about 1 M to about 4 M. In this case, the lithium salt may help improve ion conductivity by improving lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In an implementation, the lithium salt may include an imide salt, e.g., lithium bis(trifluoromethanesulfonyl) imide (LiTFSI, LiN(SO₂CF₃)₂), or lithium bis(fluorosulfonyl)imide (LiFSI, LiN(SO₂F)₂). The lithium salt may help maintain or improve ion conductivity by appropriately maintaining chemical reactivity with the ionic liquid.

The ionic liquid may have a melting point below room temperature, so it may be in a liquid state at room temperature and refers to a salt or room temperature molten salt composed of ions alone.

The ionic liquid may be a compound including a cation, e.g., an ammonium cation, pyrrolidinium cation, pyridinium cation, pyrimidinium cation, imidazolium cation, piperidinium cation, pyrazolium cation, oxazolium cation, pyridazinium cation, phosphonium cation, sulfonium cation, triazolium cation, or a mixture thereof, and at an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N—.

The ionic liquid may include, e.g., N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ion conductivity by improving the electrochemical contact area with the electrode. Accordingly, the energy density, discharge capacity, rate capability, etc. of the all-solid-state battery may be improved.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

In an implementation, the shape of the all-solid-state battery may be, e.g., a coin type, a button type, a sheet type, a stack type, a cylindrical shape, a flat type, or the like. In an implementation, the all-solid-state battery may be applied to a large-sized battery used in an electric vehicle or the like. In an implementation, the all-solid-state battery may also be used in a hybrid vehicle such as a plug-in hybrid electric vehicle (PHEV). In an implementation, it may be used in a field requiring a large amount of power storage, and may be used, e.g., in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

1. Preparation of Solid Electrolyte

An argyrodite-type sulfide solid electrolyte was synthesized through a method described below. All processes of mixing raw materials and pre-heat treatment and post-heat treatment were performed in a glove box under an argon atmosphere. The raw materials of lithium sulfide (Li₂S), phosphorus pentasulfide (P₂S₅), and lithium chloride (LiCl) were mixed in a molar ratio of 2.5:0.5:1, preparing a mixed powder. The mixed powder was uniformly mixed with a Henschel mixer and then, primarily fired at 250° C. for 5 hours in a tube furnace through which argon gas was flowing at a constant speed of 8 SLM.

The primarily fired powder was uniformly mixed again with the Henschel mixer, sifted, and then, secondarily fired at 500° C. for 10 hours in the tube furnace through which argon gas was flowing at the constant speed of 8 SLM. The secondarily fired powder was pulverized and sifted, obtaining sulfide solid electrolyte particles of Li₆PS₅Cl. This obtained sulfide solid electrolyte particles had a size (D50) of 0.85 μm.

100 parts by weight of the prepared sulfide solid electrolyte particles and 0.25 parts by weight of lithium-zirconium-oxide (LZO) having D50 of 0.13 μm and being amorphous as a result of X-ray diffraction analysis as a coating agent were mixed with the Henschel mixer. The mixed powder was heat-treated at 250° C. for 5 hours in the tube furnace through which argon gas was flowing at the constant speed of 8 SLM. Through this, a solid electrolyte having the lithium-zirconium-oxide coated on the surface of the sulfide solid electrolyte particles was prepared.

2. Manufacture of Positive Electrode

13.61 wt % of the prepared solid electrolyte, 84.9 wt % of a positive electrode active material, LiNi_{0.944}Co_{0.04}Al_{0.012}Mn_{0.004}O₂, 1 wt % of a PVdF binder, 0.35 wt % of a conductive material, carbon nanotubes, and 0.14 wt % of a dispersant, a hydrogenated nitrile butadiene rubber (HNBR), were added to a solvent, isobutyryl isobutyrate (IBIB) and then, mixed, preparing a positive electrode composition.

The prepared positive electrode composition was coated on a positive electrode current collector and then, dried and compressed (warm isostatic press (WIP), 500 Mpa, 85° C., 30 min), manufacturing a positive electrode.

3. Manufacture of All-Solid-State Rechargeable Battery Cell After preparing a catalyst by mixing carbon black (primary particle diameter of about 30 nm) and silver (Ag) (average particle diameter (D50) of about 60 nm) in a weight ratio of 3:1, 0.25 g of the catalyst was added to 2 g of an NMP solution including 7 wt % of a polyvinylidene fluoride binder and then, mixed, preparing a negative electrode catalyst layer composition. This composition was coated on a negative electrode current collector and dried, preparing a precipitation type negative electrode having a negative electrode catalyst layer on the current collector.

An argyrodite-type solid electrolyte of Li₆PS₅Cl was added to an IBIB solvent to which an acryl binder was included, preparing a composition for a solid electrolyte layer. The composition was cast on a releasing film and then, dried at ambient temperature, forming a solid electrolyte layer.

After cutting the prepared positive electrode, negative electrode, and solid electrolyte layer, the solid electrolyte layer was stacked on the positive electrode, and the negative electrode was stacked thereon. The stacked product was sealed into a pouch shape and then, pressed (warm isostatic press (WIP)) at a high temperature of 80° C. to 500 MPa for 30 minutes, manufacturing an all-solid-state rechargeable battery cell.

### Example 2

A solid electrolyte, a positive electrode, and an all-solid-state rechargeable battery cell were manufactured in the same manner as in Example 1, except that 0.5 parts by weight of the LZO coating agent was added to prepare the solid electrolyte.

### Example 3

A solid electrolyte, a positive electrode, and an all-solid-state rechargeable battery cell were manufactured in the same manner as in Example 2 except that amorphous lithium aluminum oxide (LAO; D50=0.06 μm) was used as a coating agent in the preparation of the solid electrolyte.

### Example 4

A solid electrolyte, a positive electrode, and an all-solid-state rechargeable battery cell were manufactured in the same manner as in Example 2 except that amorphous lithium-titanium-oxide (LTO; D50=0.06 μm) was used as a coating agent in the preparation of the solid electrolyte.

### Example 5

A solid electrolyte, a positive electrode, and an all-solid-state rechargeable battery cell were manufactured in the same manner as in Example 1 except that 1.0 part by weight of the LZO coating agent was added to prepare the solid electrolyte.

### Comparative Example 1

A solid electrolyte, a positive electrode, and an all-solid-state rechargeable battery cell were manufactured in the same manner as in Example 1 except that the solid electrolyte was prepared without using a LZO coating agent, and performing a heat treatment at 250° C. for 5 hours.

### Comparative Example 2

A solid electrolyte, a positive electrode, and an all-solid-state rechargeable battery cell were manufactured in the same manner as in Example 1, except that the solid electrolyte was prepared without performing the coating process.

### Comparative Example 3

A solid electrolyte, a positive electrode, and an all-solid-state rechargeable battery cell were manufactured in the same manner as in Comparative Example 2, except that LiNi_{0.944}Co_{0.04}Al_{0.012}Mn_{0.004}O₂ having a Li₂O—ZrO₂ buffer layer was used as the positive electrode active material. In the positive electrode of Comparative Example 3, an LZO-coated positive electrode active material and an uncoated solid electrolyte were used.

In Comparative Example 3, the buffer layer of the positive electrode active material was formed in a wet coating method as follows. After mixing 2-propanol (from which moisture had been removed), a methanol solution containing 10% lithium methoxide, and zirconium isopropoxide in a molecular ratio (molar ratio) of 200:2:1, the positive electrode active material was dispersed therein. In order to prevent aggregation of the positive electrode active material particle, the solvent was evaporated at 50° C. under vacuum, while irradiating ultrasonic waves. A resulting material therefrom was filtered and heat-treated at 350° C. under an air atmosphere for 1 hour, obtaining the positive electrode active material coated with about 0.25 wt % of Li₂O—ZrO₂ as the buffer layer.

Table 1 shows design details of the solid electrolytes of Examples 1 to 5 and Comparative Examples 1 to 3.

TABLE 1

| | Additional | LZO | LAO | LTO |
|---|---|---|---|---|
| | heat | (parts by | (parts by | (parts by |
| | treatment | weight) | weight) | weight) |
| Example 1 | 250° C. | 0.25 | — | — |
| Example 2 | | 0.5 | — | — |
| Example 3 | | — | 0.5 | — |
| Example 4 | | — | — | 0.5 |
| Example 5 | | 1.0 | — | — |
| Comparative Example 1 | | — | — | — |
| Comparative Example 2 | None | — | — | — |
| Comparative Example 3 | None | — | — | — |

### Evaluation Example 1: Evaluation of Particle Size Distribution of Solid Electrolyte

The particle size distributions of the solid electrolytes prepared in Examples 1 to 5 and Comparative Examples 1 and 2 were measured. The particle size distribution was measured by using xylene, from which moisture was removed, as a solvent and a particle size analyzer using a laser diffraction.

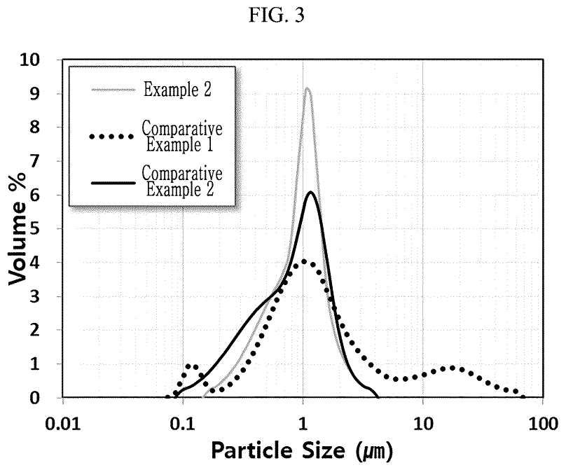

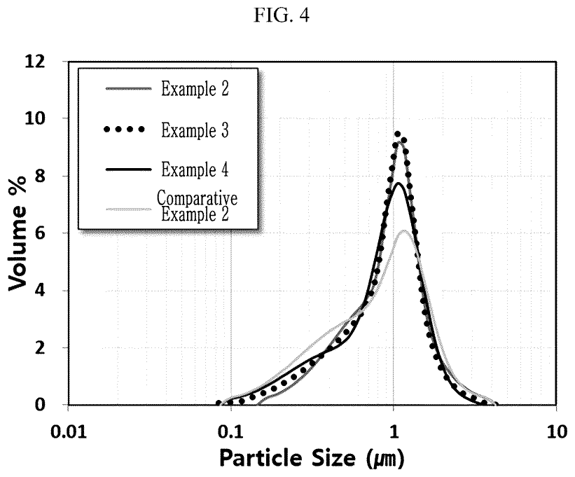

FIG. 3 shows particle size distribution curves of the solid electrolytes prepared in Example 2 (LZO 0.5), Comparative Example 1 (250° C.—not), and Comparative Example 2 (not—not), and FIG. 4 shows particle size distribution curves of the solid electrolytes prepared in Example 2 (LZO 0.5), Example 3 (LAO 0.5), Example 4 (LTO 0.5), and Comparative Example 2 (not—not). In the particle size distribution curves of FIGS. 3 and 4, the horizontal axis is the particle size (μm), and the vertical axis is the cumulative volume (volume %) of the particles.

In addition, in each particle size distribution of the solid electrolytes of Examples 1 to 5 and Comparative Examples 1 and 2, a cumulative volume 10% as D10, a cumulative volume 50% as D50, and a cumulative volume 90% as D90 are shown in Table 2. Furthermore, (D90−D10)/D50 was calculated to compare wideness of each particle size distribution and then, provided as Span in Table 2.

TABLE 2

| unit μm | D10 | D50 | D90 | Span |
|---|---|---|---|---|
| Example 1 | 0.286 | 0.942 | 1.564 | 1.4 |
| Example 2 | 0.387 | 0.938 | 1.556 | 1.2 |
| Example 3 | 0.333 | 0.919 | 1.454 | 1.2 |
| Example 4 | 0.286 | 0.884 | 1.492 | 1.4 |
| Example 5 | 0.355 | 1.112 | 2.327 | 1.8 |
| Comparative Example 1 | 0.369 | 1.144 | 12.890 | 10.9 |
| Comparative Example 2 | 0.260 | 0.848 | 1.644 | 1.6 |

Referring to FIG. 3, in the case of Comparative Example 1 in which only heat treatment was performed without a coating agent, peaks are shown in several places, indicating that the solid electrolyte particles were aggregated, compared to Comparative Example 2 before heat treatment. In addition, in Table 2, Comparative Example 1 significantly increased the D90 value and the Span value compared to Comparative Example 2, according to particle aggregation. If the heat treatment were to be additionally performed in order to increase ion conductivity of the pulverized sulfide solid electrolyte particles and the like, there could be a problem of aggregation among the particles.

In Examples 1 to 5, referring to FIGS. 3, 4 and Table 2, they had a very even particle size distribution without aggregation or growth of particles after coating.

In addition, through this particle size distribution analysis, in the final solid electrolytes, coating agent particles were not separately present from the sulfide solid electrolyte particles, but rather evenly coated on the surface of the sulfide solid electrolyte particles.

### Evaluation Example 2: X-Ray Diffraction Analysis of Solid Electrolyte

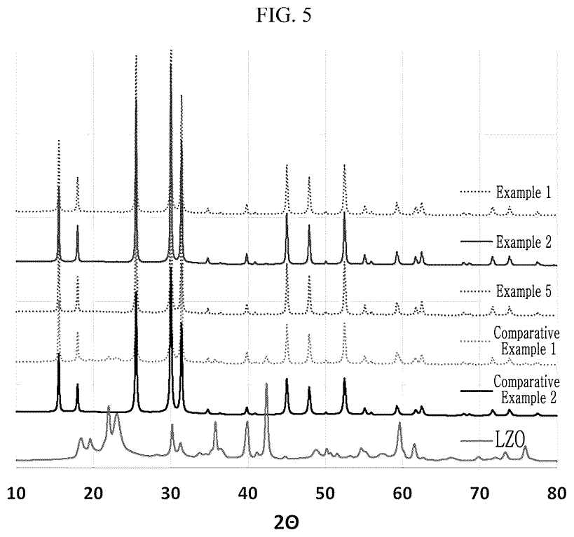

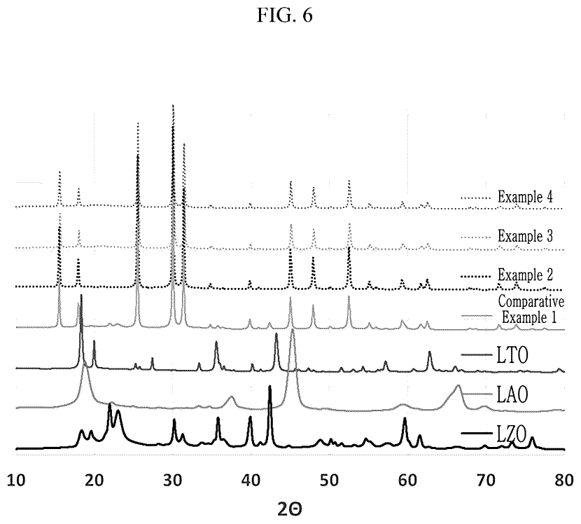

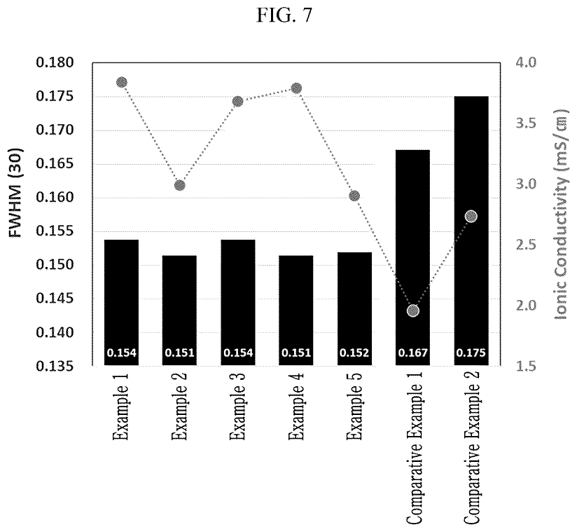

X-ray diffraction analysis was performed on the solid electrolytes and LZO of Examples 1, 2, and 5 and Comparative Examples 1 and 2, and the results are shown in FIG. 5. The solid electrolytes of Examples 2 to 4 and Comparative Example 1, LZO, LAO, and LTO were subjected to X-ray diffraction analysis, and the results are shown in FIG. 6. In addition, in the X-ray diffraction analysis of the solid electrolytes of Examples 1 to 5 and Comparative Examples 1 to 2, the full width at half maximum at the peak (main peak) near 30° having the highest diffraction intensity was calculated and shown in a bar graph in FIG. 7.

Referring to FIG. 5, in Examples 1, 2, and 5 in which the LZO coating was performed, LZO peaks do not appear separately, and even in Example 5 having a high coating agent content, LZO peaks do not appear, and thus lithium-zirconium-oxide present on the surface of the sulfide solid electrolyte particles may have a very low crystallinity, e.g., to exist in an amorphous state. Referring to FIG. 6 performing the same analysis by varying types of the coating agent, Example 3 exhibits no LAO peak, and Example 4 exhibits no LTO peak, which all show that lithium-metal-oxides located on the surfaces of the sulfide solid electrolyte particles all existed in an amorphous form. Combining Evaluation Examples 1 and 2, the lithium-metal-oxides were evenly coated in an amorphous state on the surfaces of the sulfide solid electrolyte particles.

In FIG. 5, Examples 1, 2, and 5 and Comparative Example 1 exhibited a higher diffraction peak than Comparative Example 2 (in which no coating process was performed), and compared with Comparative Example 1 (in which the heat treatment was performed and without using a coating agent), Examples 1, 2 and 5 using the coating agent exhibited a further higher diffraction peak. Accordingly, when the heat treatment was performed within a specific temperature range after coating amorphous lithium-metal-oxides, the coating agent may help suppress aggregation of the solid electrolyte particles and may help promote growth of crystals.

Referring to FIG. 7, showing a full width at half maximum of a main peak as a bar graph, Comparative Example 2 (before the heat treatment, e.g., in the state of pulverized sulfide solid electrolyte particles) exhibited a high full width at half maximum of about 0.175, and Examples 1 to 5 exhibited a significantly reduced full width at half maximum of about 0.155 or less, which shows an increase in a crystal size and also, an increase in crystallinity. Comparative Example 1 (in which the heat treatment was performed at 250° C. and without the coating agent), compared with Comparative Example 2, exhibited a little reduced full width at half maximum and thus growth of crystals, and a smaller increase in a crystal size than the Examples. Comparative Example 1 exhibited aggregation of the particles as in Evaluation Example 1, which may be understood to have a small increase in a crystal size due to a loss of heat energy.

Accordingly, when the amorphous lithium-metal-oxides were appropriately coated on the surface of the sulfide solid electrolyte particles and then, heat-treated within a specific temperature range, the solid electrolyte particles may be suppressed from aggregation, and a crystal size thereof may be increased.

Evaluation Example 3: Evaluation of Ion Conductivity of Solid Electrolyte

0.15 g of each solid electrolyte according to Examples 1 to 5 and Comparative Examples 1 to 2 was filled or charged and then, pressed with a pressure of 40 kgf/cm² to manufacture torque cells. After performing electrochemical impedance spectroscopy (EIS) of the manufactured cells to calculate ion conductivity, the results are shown as a dotted line graph in FIG. 7. EIS was performed at amplitude of about 10 mV and a frequency of 0.1 Hz to 10⁶ Hz under an air atmosphere at 25° C. The ion conductivity was calculated by obtaining a reference value from a circular arc of a Nyquist plot through EIS and considering a thickness, an area, and the like of each of the cells.

Referring to FIG. 7, Comparative Example 1, in which an additional heat treatment was performed, exhibited a lowered full width at half maximum (FWHM) and improved crystallinity, compared with Comparative Example 2, in which a coating process was not performed, and the ion conductivity was reduced due to the particle aggregation.

The Examples all exhibit improved ion conductivity, compared with the Comparative Examples. Comparing Examples 2 to 4, which used different types of coating agents with the same content, the solid electrolytes exhibited different crystal growth and ion conductivity depending on the types of the coating agents. The reason may be that the coating agent of Example 2 had D50 of 0.13 μm, and the coating agents of Examples 3 and 4 had D50 of 0.06 μm, which could cause a different coating thickness or shape on the surface of the sulfide solid electrolyte particles. In Example 5, an increased content of the coating agent may generate aggregation or serve resistance on the surface of the sulfide solid electrolyte particles, which may result in a little deteriorating the ion conductivity.

### Evaluation Example 4: Evaluation of Moisture Stability of Solid Electrolyte

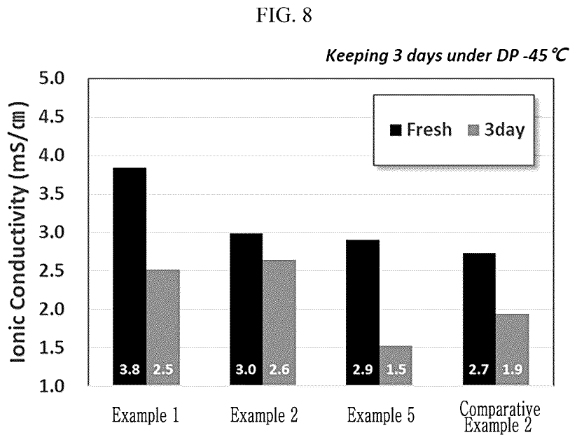

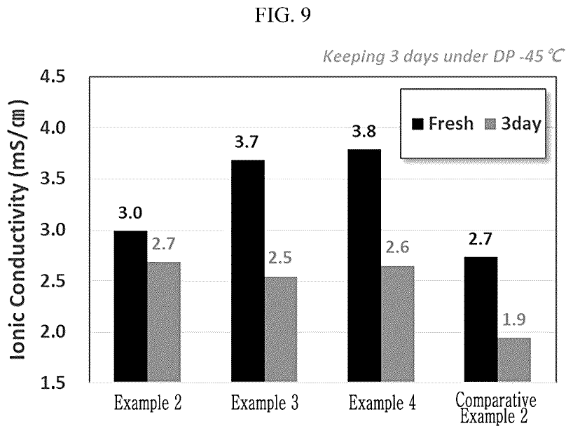

Each of the solid electrolytes according to Examples 1 to 5 and Comparative Example 2 were allowed to stand in a dry room for 3 days at a dew point temperature of −45° C. and then, measured with respect to ion conductivity in the same manner as in Evaluation Example 3. FIG. 8 shows the results of Examples 1, 2, and 5 and Comparative Example 2, and FIG. 9 shows the results of Examples 2 to 4 and Comparative Example 2. In FIG. 8 and FIG. 9, the ion conductivity before being allowed to stand is provided as a black bar graph, and the ion conductivity after allowed to stand is provided as an gray bar graph.

Referring to FIG. 8, when the surface of the solid electrolytes is well protected with the coating agent, stability to moisture is increased. When the coating agent was used in a small amount as in Example 1, a coating layer was thin on the solid electrolyte surface or exposed a lot of the surface, and initial ion conductivity was high. The surface was not sufficiently protected, and after being allowed to stand, the ion conductivity was relatively low. In Example 5 using an excessive content of the coating agent, the more solid electrolyte surface was exposed due to aggregation of the coating agent itself after the heat treatment, and the ion conductivity was relatively low after being allowed to stand.

Referring to FIG. 9, when the surface of the solid electrolyte was protected by appropriately coating lithium-metal-oxides thereon, moisture stability is improved, compared with Comparative Example 2 having no coating.

### Evaluation Example 5: Evaluation of Initial Charge and Discharge Capacity of All-Solid-State Rechargeable Battery Cell

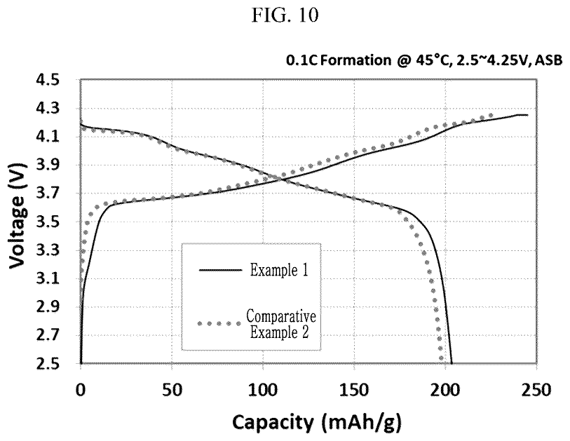

All-solid-state rechargeable battery cells according to Examples 1, 2, and 5 and Comparative Examples 1 to 3 were charged to an upper limit voltage of 4.25 V at a constant current of 0.1 C and to 0.05 C at a constant voltage and then, discharged to a discharge cut-off voltage of 2.5 V at 0.1 C at 45° C. to measure initial discharge capacity, and the results are shown in Table 3. In addition, Example 1 and Comparative Example 2 were compared with respect to a voltage according to charge and discharge capacity, and the results are shown in FIG. 10.

TABLE 3

| | Charge capacity | Discharge capacity | Efficiency |
|---|---|---|---|
| | (mAh/g) | (mAh/g) | (%) |
| Example 1 | 245 | 204 | 83.0% |
| Example 2 | 244 | 201 | 82.6% |
| Example 5 | 244 | 200 | 82.1% |
| Comparative Example 1 | 231 | 183 | 79.0% |
| Comparative Example 2 | 227 | 198 | 87.3% |
| Comparative Example 3 | 240 | 200 | 83.3% |

Referring to FIG. 10, in both the charge and the discharge, Example 1 exhibited lower resistance than Comparative Example 2 (having no buffer layer). Accordingly, when the solid electrolyte was coated with lithium metal oxides in an amorphous state, a depletion layer generated during lithium transfer between positive active material and solid electrolyte may be well controlled.

However, Comparative Example 1, in which the solid electrolyte was heat-treated without coating, exhibited the particle aggregation, as in Evaluation Example 1, which adversely affected dispersibility of the solid electrolyte in a positive electrode plate. In the all-solid-state rechargeable battery cell of Comparative Example 1, in which lithium ions are not easily transferred, exhibited deteriorated charge capacity and discharge capacity, as shown in Table 3.

In addition, referring to Table 3, the all-solid-state rechargeable battery cells of Examples 1, 2, and 5 and the like, compared with Comparative Example 2, all exhibited improved initial charge capacity and discharge capacity and even compared with Comparative Example 3, in which a buffer layer was introduced into a positive active material, exhibited high initial charge and discharge capacity, and excellent all-solid-state rechargeable battery cells may be realized.

In Comparative Example 3, a buffer layer technology may control the depletion layer in a positive electrode by coating the positive active material, but failed in improving the positive active material itself but improved only a mutual reaction with a solid electrolyte. However, referring to Evaluation Examples 4 and 5, some example embodiments were to coat lithium-metal-oxides on the solid electrolyte so that it may perform complex functions of a buffer layer and an electrolyte protective layer to facilitate the manufacture of an all-solid-state rechargeable battery cell.

### Evaluation Example 6: Cycle-Life Characteristics of All-Solid-State Rechargeable Battery Cells

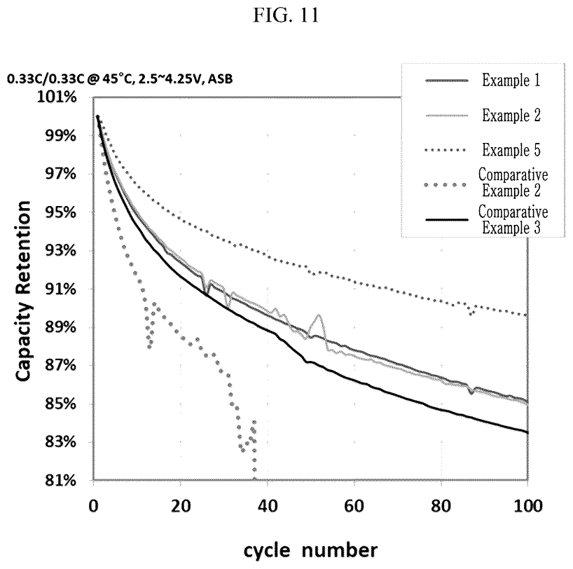

The cells of Examples 1, 2, and 5 and Comparative Examples 2 and 3, as in Evaluation Example 5, after the initial charge and discharge, were repeatedly charged at 0.33 C and discharged at 0.33 C within a voltage range of 2.5 V to 4.25 V at 45° C. to evaluate cycle-life characteristics, and the results are shown in FIG. 11.

Referring to FIG. 11, compared with Comparative Example 3, the Examples exhibited excellent capacity retention. The reason may be that amorphous lithium metal oxides coated on the electrolyte may well suppress a reaction between the positive active material and the sulfide solid electrolyte. However, Comparative Example 2, which had no buffer layer for suppressing the reaction between the positive active material and the sulfide solid electrolyte, proceeded only up to 40 cycles, and the cycle-life evaluation was no longer conducted.

By way of summation and review, a solid electrolyte, compared to the liquid electrolyte, may have low ion conductivity, resistance on the interface with solid particles of a positive electrode active material and the like in a battery, deterioration of the ion conduction performance by formation of a depletion layer by solid-to-solid bonding, and the like.

In order to address these issues, doping various elements into the positive electrode active material particles used with the solid electrolyte and forming a buffer layer including various elements such as B, Nb, Zr, and the like on the surface of the positive electrode active material particles have been used. However, these methods could have difficulties in mass production, could cause coat and environmental problems, and could still have limitations in improving performance of the all-solid-state battery.

One or more embodiments may provide a solid electrolyte with high ion conductivity and high crystallinity and improved moisture stability, which may be applied to a positive electrode to help improve capacity and charge/discharge efficiency of the all-solid-state rechargeable battery and to improve cycle-life characteristics.

The positive electrode for an all-solid-state rechargeable battery according to some example embodiments may include a solid electrolyte having high ion conductivity and high crystallinity and excellent moisture stability, so that it is possible to use the positive electrode active material without forming a buffer layer, which is used in liquid electrolyte systems, as it is, and to improve the charge-discharge efficiency, capacity, and cycle-life characteristics of all-solid-state rechargeable batteries

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive electrode for an all-solid-state rechargeable battery, the positive electrode comprising:
a current collector; and
a positive electrode active material layer on the current collector,
wherein:
the positive electrode active material layer includes a positive electrode active material and a solid electrolyte,
the solid electrolyte includes:
sulfide solid electrolyte particles, and
a lithium-metal-oxide on a surface of the sulfide solid electrolyte particles, and
in an X-ray diffraction analysis of the solid electrolyte, a full width at half maximum of a main peak is less than or equal to about 0.160.

2. The positive electrode as claimed in claim 1, wherein, in the lithium-metal-oxide, the metal is Al, B, Ca, Ce, Cr, Fe, Mg, Mo, Nb, Si, Sn, Sr, Ta, V, W, or Zr.

3. The positive electrode as claimed in claim 1, wherein the lithium-metal-oxide is included in the solid electrolyte in an amount of about 0.01 wt % to about 3 wt %, based on a total weight of the solid electrolyte.

4. The positive electrode as claimed in claim 1, wherein the lithium-metal-oxide is included in the solid electrolyte in an amount of about 0.01 wt % to about 0.8 wt %, based on a total weight of the solid electrolyte.

5. The positive electrode as claimed in claim 1, wherein the lithium-metal-oxide is amorphous.

6. The positive electrode as claimed in claim 1, wherein the sulfide solid electrolyte particles include an argyrodite-type sulfide.

7. The positive electrode as claimed in claim 1, wherein an average particle diameter (D50) of the solid electrolyte is about 0.1 μm to about 5.0 μm.

8. The positive electrode as claimed in claim 1, wherein an average particle diameter (D50) of the sulfide solid electrolyte is about 0.1 μm to about 2.0 μm.

9. The positive electrode as claimed in claim 1, wherein a value of (D90−D10)/D50 in a particle size distribution for the solid electrolyte is greater than about 1 and less than or equal to about 5.

10. The positive electrode as claimed in claim 1, wherein the solid electrolyte is included in the positive electrode active material layer in an amount of about 0.5 wt % to about 35 wt %, based on a total weight of the positive electrode active material layer.

11. The positive electrode as claimed in claim 1, wherein:
the positive electrode active material is in the form of particles, and
the particles do not include a buffer layer.

12. The positive electrode as claimed in claim 1, wherein the positive electrode active material includes a lithium cobalt oxide, lithium nickel oxide, a lithium nickel cobalt oxide, a lithium nickel cobalt aluminum oxide, a lithium nickel cobalt manganese oxide, a lithium nickel manganese oxide, a lithium manganese oxide, a lithium iron phosphate, or a combination thereof.

13. The positive electrode as claimed in claim 1, wherein:
the positive electrode active material includes a lithium nickel oxide represented by Chemical Formula 1, a lithium cobalt oxide represented by Chemical Formula 2, a lithium iron phosphate compound represented by Chemical Formula 3, or a combination thereof,
Liₐ₁Niₓ₁M¹_{y1}M²_{1-x1-y1}O₂ [Chemical Formula 1]
in Chemical Formula 1, 0.9≤a1≤1.8, 0.3≤x1≤1, 0≤y1≤0.7, and M¹ and M² are each independently Al, B, Ba, Ca, Ce, Co, Cr, Cu, F, Fe, Mg, Mn, Mo, Nb, P, S, Si, Sr, Ti, V, W, or Zr,
Liₐ₂Coₓ₂M³₁₋ₓ₂O₂ [Chemical Formula 2]
in Chemical Formula 2, 0.9≤a2≤1.8, 0.6≤x2≤1, and M³ is Al, B, Ba, Ca, Ce, Cr, Cu, F, Fe, Mg, Mn, Mo, Nb, P, S, Si, Sr, Ti, V, W, or Zr, and
Liₐ₃Feₓ₃M⁴₍₁₋ₓ₃₎PO₄ [Chemical Formula 3]
in Chemical Formula 3, 0.9≤a3≤1.8, 0.6≤x3≤1, and M⁴ is Al, B, Ba, Ca, Ce, Co, Cr, Cu, F, Fe, Mg, Mn, Mo, Nb, P, S, Si, Sr, Ti, V, W, or Zr.

14. The positive electrode as claimed in claim 1, wherein an average particle diameter (D50) of the positive electrode active material is about 3 μm to about 25 μm.

15. The positive electrode as claimed in claim 1, wherein the positive electrode active material layer includes:
about 50 wt % to about 99.5 wt % of the positive electrode active material,
about 0.5 wt % to about 35 wt % of the solid electrolyte,
about 0 wt % to about 10 wt % of a binder, and
about 0 wt % to about 5 wt % of a conductive material, based on a total weight of the positive electrode active material layer.

16. An all-solid-state rechargeable battery, comprising:
the positive electrode as claimed in claim 1,
a negative electrode, and
a solid electrolyte layer between the positive electrode and the negative electrode.

17. The all-solid-state rechargeable battery as claimed in claim 16, wherein the negative electrode includes a current collector and a negative electrode active material layer or a negative electrode catalyst layer on the current collector.

18. The all-solid-state rechargeable battery as claimed in claim 16, wherein the negative electrode includes:
a current collector,
a negative electrode catalyst layer on the current collector, and
a lithium metal layer formed during initial charging between the current collector and the negative electrode catalyst layer.

19. The all-solid-state rechargeable battery as claimed in claim 16, wherein:
the solid electrolyte layer includes a solid electrolyte, and
an average particle diameter (D50) of the solid electrolyte included in the positive electrode is smaller than an average particle diameter (D50) of the solid electrolyte included in the solid electrolyte layer.

20. The all-solid-state rechargeable battery as claimed in claim 19, wherein:
the average particle diameter (D50) of the solid electrolyte included in the positive electrode is about 0.5 μm to about 2.0 μm, and
the average particle diameter (D50) of the solid electrolyte included in the solid electrolyte layer is about 2.1 μm to about 5.0 μm.
